(19) United States
(12) Patent Application Publication
(10) Pub. No.: US 2008/0018668 A1
(43) Pub. Date: Jan. 24, 2008

(54) Image Processing Device and Image Processing Method

(76) Inventor: Masaki Yamauchi, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/629,618

(22) PCT Filed: Jul. 22, 2005
(86) PCT No.: PCT/JP05/13505

§ 371 Date: Dec. 15, 2006

(30) Foreign Application Priority Data
Jul. 23, 2004 (JP) 2004-215233

(51) Int. Cl. G09G 5/00; G06T 15/20

(52) U.S. Cl. 345/633; 345/427

(57) ABSTRACT

An image processing device of the present invention enables reduction in the amount of user's operational tasks in a generation of three-dimensional information from a still image.

The image processing device includes a three-dimensional generation unit (130), a spatial composition specification unit (112), an object extraction unit (122), a three-dimensional information user IF unit (131), a spatial composition user IF unit (111), and an object user IF unit (121), respectively extracts a spatial composition and an object from an obtained original image and generates three-dimensional information regarding the object by placing the object in a virtual space and an image shot with a camera that moves in the virtual space, which enables generation of a three-dimensional image viewed from a viewpoint different from the viewpoint employed in shooting the original image.

### TECHNICAL FIELD

The present invention relates to a technique of generating a three-dimensional image from a still image, and in particular, to a technique of extracting, from a still image, an object representing a person, an animal, a building or the like, and generating three-dimensional information which is information indicating a depth of the whole still image which includes the object.

### BACKGROUND ART

One of the conventional methods for obtaining three-dimensional information from a still image is to generate three-dimensional information with respect to an arbitrary viewing direction from still images shot by plural cameras. The method of generating an image viewed from a viewpoint or along a line of sight different from the one employed in the shooting, by extracting three-dimensional information regarding images at the time of shooting is disclosed (see Patent Reference 1). The Patent Reference 1 describes an image processing circuit, equipped with an image input unit placed laterally for inputting images, and a distance calculation unit which calculates distance information of an object, which generates an image viewed from an arbitrary viewpoint or along an arbitrary line of sight. The same kind of conventional technique is disclosed in the Patent References 2 and 3 presenting a highly versatile image storage reproduction apparatus which stores plural images and parallaxes.

The Patent Reference 4 presents the method for shooting an object from at least three different positions, and recognizing with high speed an exact three-dimensional form of the object. The Patent Reference 5, among many others, discloses a system using plural cameras.

The Patent Reference 6 describes the case of shooting a moving object (vehicle) with a fish-eye TV camera while the vehicle runs for a certain amount of distance and obtaining a silhouette of the vehicle by removing a background image from each image, with the purpose to obtain a form of an object using one camera without rotating the object. Movement traces of the ground contact points of the wheels of the vehicle in each image are obtained, and then based on this, a relative position between a viewpoint of the camera and the vehicle in each image is obtained. Each of the silhouettes is distributed in a projection space based on the relative positional relationship, and the respective silhouettes are projected in the projection space, so as to obtain the form of the vehicle. An epipolar-based method is widely known as a method for obtaining three-dimensional information from plural images. In the Patent Reference 6; however, with the use of plural cameras, three-dimensional information is obtained by obtaining plural images of a moving object in time series, instead of obtaining images of an object from plural viewpoints.

A package software “Motion Impact” produced by HOLON, Inc. can be raised as an example of the method for extracting a three-dimensional structure from a single still image and displaying it. The software virtually creates three-dimensional information from one still image and generates three-dimensional information as in the following steps.

1) Prepare an original image (image A).

2) Using another image processing software (e.g. retouch software), create “an image (image B) from which an object to be made three-dimensional is removed” and “an image (image C) in which only an object to be made three-dimensional is masked”.

3) Register the respective images A, B and C into “Motion Impact”.

4) Set a vanishing point in the original image, and set a three-dimensional space in a photograph.

5) Select an object to be transformed into a three-dimensional form.

6) Set a camera angle and a camera motion.

FIG. 1 is a flowchart showing a flow of the conventional processing of generating three-dimensional information from still images and further creating a three-dimensional video (Note that the steps presented in the shaded areas among the steps shown in FIG. 1 are the steps to be manually operated by the user).

When a still image is inputted, the user manually inputs information presenting a spatial composition (hereinafter to be referred to as “spatial composition information”) (S900). More precisely, the number of vanishing points is determined (S901), positions of the vanishing points are adjusted (S902), an angle of the spatial composition is inputted (S903), and position and size of the spatial composition are adjusted (S904).

Then, a masked image obtained by masking an object is inputted by the user (S910), and three-dimensional information is generated based on the placement of mask and the spatial composition information (S920). To be precise, when the user selects an area in which the object is masked (S921), and selects one side (or one face) of the object (S922), whether or not the selected side (or face) comes in contact with the spatial composition is judged (S923). In the case where the selected side (or plane) does not come in contact with the spatial composition (No in S923), “no contact” is inputted (S924), and in the case where the selected side (or face) gets in contact with the spatial composition (Yes in S923), coordinates indicating the contacting part is inputted (S925). The same processing as described above is performed onto all the faces of the object (S922-S926).

After the above processing is performed onto all the objects (S921-S927), all the objects are mapped in a space specified by the composition, and three-dimensional information for generating a three-dimensional video is generated (S928).

Then, information regarding camera work is inputted by the user (S930). To be more concrete, when a path on which a camera moves is selected by the user (S931), the path is reviewed (S932), and then, a final camera work is determined (S933).

After the above processing is terminated, a depth feel is added by a morphing engine which is one of the functions of the software as mentioned above (S940), so as to complete a video to be presented to the user.

Patent Reference 1: The Japanese Laid-Open Application No. 09-009143.

Patent Reference 2: The Japanese Laid-Open Application No. 07-049944.

Patent Reference 3: The Japanese Laid-Open Application No. 07-095621.

Patent Reference 4: The Japanese Laid-Open Application No. 09-091436.

Patent Reference 5: The Japanese Laid-Open Application No. 09-305796.

Patent Reference 6: The Japanese Laid-Open Application No. 08-043056.

### DISCLOSURE OF INVENTION

### Problems that Invention is to Solve

As described above, many of the conventional methods for obtaining three-dimensional information from plural still images or plural still images shot by plural cameras are presented.

However, the method for automatically analyzing a three-dimensional structure of a still image and displaying the analysis is not established and most of the operations are performed manually as described above.

With the conventional art, it is necessary to manually carry out almost all the operations, as shown in FIG. 1. In other words, the only tool which is presently provided is a tool for manually inputting, as required each time, a camera position for a camera work after the generation of three-dimensional information.

As is already described above, each of the objects in a still image is extracted manually, an image to be used as a background is created also by hand as a separate process, and each object is manually mapped into virtual three-dimensional information after manually setting, as a different process, spatial information related to drawing such as vanishing points. This causes difficulty in creating three-dimensional information. Also, no solution can be provided in the case where vanishing points are located outside an image.

In addition, the display of an analysis on a three-dimensional structure also has problems such that the setting of a camera work is complicated, and that the effects to be performed with the use of depth information are not taken into account. This is a critical issue in its use intended especially for entertainment.

The present invention is to solve the above-mentioned conventional problems, and an object of the present invention is to provide an image processing device which can reduce the amount of work loads imposed on the user in generating three-dimensional information from a still image.

### Means to Solve the Problems

In order to solve the above problems, the image processing device according to the present invention is an image processing device which generates three-dimensional information from a still image, and includes: an image obtainment unit which obtains a still image; an object extraction unit which extracts an object from the obtained still image; a spatial composition specification unit which specifies, using a characteristic of the obtained still image, a spatial composition representing a virtual space which includes a vanishing point; and a three-dimensional information generation unit which determines placement of the object in the virtual space by associating the specified spatial composition with the extracted object, and generates three-dimensional information regarding the object based on the placement of the object.

With the structure as described above, three-dimensional information is automatically created from one still image; therefore, it is possible to reduce the number of the tasks carried out by the user in the generation of the three-dimensional information.

The image processing device also includes: a viewpoint control unit which moves a position of a camera, assuming that the camera is set in the virtual space; an image generation unit which generates an image in the case where an image is shot with the camera from an arbitrary position; and an image display unit which displays the generated image.

According to the above structure, it is possible to generate a new image derived from a still image, using generated three-dimensional information.

The viewpoint control unit controls the camera to move within a range in which the generated three-dimensional information is located.

With the technical feature as described above, a part of an image shot with a camera that moves in a virtual space, which has no data is no longer displayed so that the image quality can be enhanced.

The viewpoint control unit further controls the camera to move in a space in which the object is not located.

According to the structural feature as described above, it is possible to prevent an image, which is shot with a camera that moves in a virtual space, from crashing into or passing through an object. Thus, the image quality can be enhanced.

The viewpoint control unit further controls the camera to shoot a region in which the object indicated by the generated three-dimensional information is located.

With such structural feature as described above, it is possible to prevent degradation of quality as can be seen in the case of not finding data representing the rear face of an object when a camera moving in a virtual space performs panning, zooming, and rotation.

The viewpoint control unit further controls the camera to move in a direction toward the vanishing point.

According to the above structural feature, it is possible to obtain a visual effect which gives an impression as if the user gets into the image shot with a camera moving in a virtual space, and the image quality can be thus improved.

The viewpoint control unit further controls the camera to move in a direction toward the object indicated by the generated three-dimensional information.

With the above-mentioned structural feature, it is possible to obtain a visual effect which gives an impression as if the image shot by a camera moving in a virtual space approaches an object. Thus, the image quality can be improved.

The object extraction unit specifies two or more linear objects which are unparalleled to each other from among the extracted objects, and the spatial composition specification unit further estimates a position of one or more vanishing points by extending the specified two or more linear objects, and specifies the spatial composition based on the specified two or more linear objects and the estimated position of the one or more vanishing points.

According to the structural feature as described above, it is possible to automatically extract three-dimensional information from a still image, and exactly reflect spatial composition information. Thus, the quality of the whole image to be generated can be enhanced.

The spatial composition specification unit further estimates the vanishing point outside the still image.

With the structural feature as stated above, it is possible to precisely obtain spatial composition information even for an image (a large majority of general photos, i.e., most of the snapshots) which does not include any vanishing points. Thus, the quality of the whole image to be generated can be enhanced.

The image processing device further includes a user interface unit which receives an instruction from a user, wherein the spatial composition specification unit further corrects the specified spatial composition according to the received user's instruction.

With the structure as described above, it is easy to reflect user's preferences regarding spatial composition information, and thus the quality can be enhanced on the whole.

The image processing device may further include a spatial composition template storage unit which stores a spatial composition template which is a template of spatial composition, wherein the spatial composition specification unit may select one spatial composition template from the spatial composition storage unit, utilizing the characteristic of the obtained still image, and specify the spatial composition using the selected spatial composition template.

The three-dimensional information generation unit further calculates a contact point at which the object comes in contact with a horizontal plane in the spatial composition, and generates the three-dimensional information for the case where the object is located in the position of the contact point.

According to the structural features as described above, it is possible to accurately specify a spatial placement of an object, and improve the quality of an image on the whole. For example, in the case of a photo presenting a whole image of a human, it is possible to map the human into a more correct spatial position by calculating a contact point at which the feet of the human come in contact with a horizontal plane.

The three-dimensional information generation unit further changes a plane at which the object comes in contact with the spatial composition, according to a type of the object.

According to the structural feature as stated above, a contact plane can be changed depending on the type of objects. Thus, it is possible to obtain a spatial placement with more reality, and thereby to improve the quality of the whole image. For instance, any cases can be flexibly handled as in the following: in the case of a human, a contact point at which the feet come in contact with a horizontal plane can be used; in the case of a signboard, a contact point at which the signboard comes in contact with a lateral plane may be used; and in the case of an electric light, a contact point at which the light comes in contact with a ceiling plane can be used.

In the case of not being able to calculate the contact point at which the object comes in contact with the horizontal plane in the spatial composition, the three-dimensional information generation unit further (a) calculates a virtual contact point at which the object comes in contact with the horizontal plane, by interpolating or extrapolating at least one of the object and the horizontal plane, and (b) generates the three-dimensional information for the case where the object is located in the virtual contact point.

According to the structural feature as described above, it is possible to specify a spatial placement of an object more accurately even in the case where the object does not get in contact with a horizontal plane as in a photograph from the waist up. Thus, quality of the whole image can be enhanced.

The three-dimensional information generation unit further generates the three-dimensional information by placing the object in the space after applying a predetermined thickness to the object.

With the above structural feature, it is possible to place an object within a space in a more natural way, and thus the quality of the whole image can be enhanced.

The three-dimensional information generation unit further generates the three-dimensional information by applying an image processing of blurring a periphery of the object or sharpening the periphery of the object.

According to the structural feature as described above, it is possible to place an object within a space in a more natural way, and thus the quality of the whole image can be enhanced.

The three-dimensional information generation unit further constructs at least one of the following data, using data of an unhidden object: data of a background which is missing due to the background being hidden behind the object; and data of other object.

With the above structural feature, it is possible to place an object within a space in a more natural way, and thus the quality of the whole image can be enhanced.

The three-dimensional information generation unit further constructs data representing a back face and a lateral face of the object, based on data representing a front face of the object.

With the above structural feature, it is possible to place an object within a space in a more natural way, and thus the quality of the whole image can be enhanced.

The three-dimensional information generation unit further dynamically changes a process regarding the object, based on a type of the object.

With the above structural feature, it is possible to place an object within a space in a more natural way, and thus the quality of the whole image can be enhanced.

Note that the present invention can be realized not only as the image processing method which includes, as steps, the characteristic components in the image processing device, but also as a program which causes a personal computer or the like to execute these steps. Such program can be surely distributed via a storage medium such as a DVD and the like, and a transmission medium such as the Internet and the like.

### EFFECTS OF THE INVENTION

According to the image processing device of the present invention, it is possible, with very simple operations which have not been realized with the conventional image processing device, to generate three-dimensional information from a photograph (e.g. still image), and reconstruct the photograph into an image which has a depth. By shooting a three-dimensional space with a mobile virtual camera, it is possible to enjoy a still image as a moving picture. The present image processing device can thus provide a new way of enjoying photographs.

### BRIEF DESCRIPTION OF DRAWINGS

FIG. 1 is a flowchart showing the conventional process of generating three-dimensional information from a still picture.

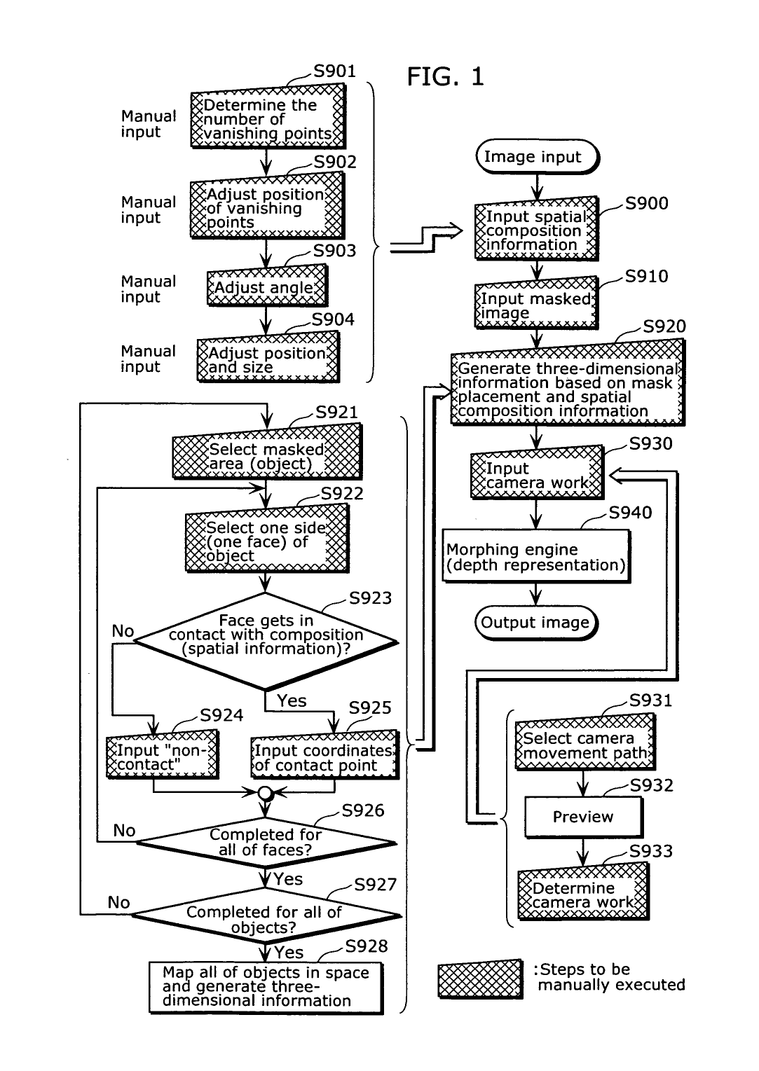

FIG. 2 is a block diagram showing a functional structure of the image processing device according to the embodiment.

FIG. 3A shows an example of an original image to be inputted into an image obtainment unit according to the embodiment. FIG. 3B shows an example of an image generated by binarizing the original image shown in FIG. 2A. An original image and an example of binarization of the original image are shown.

FIG. 4A shows an example of edge extraction according to the embodiment. FIG. 4B shows an example of an extraction of spatial composition according to the embodiment. FIG. 4C shows an example of a screen for confirming on the spatial composition according to the embodiment.

FIGS. 5A and 5B show examples of a spatial composition extraction template according to the first embodiment.

FIGS. 6A and 6B show examples of a magnified spatial composition extraction template according to the first embodiment.

FIG. 7A shows an example of an extraction of an object, according to the first embodiment. FIG. 7B shows an example of an image generated by synthesizing an extracted object and a determined spatial composition, according to the first embodiment.

FIG. 8 shows an example of a setting of a virtual viewpoint according to the first embodiment.

FIGS. 9A and 9B show examples of a generation of an image seen from a changed viewpoint, according to the first embodiment.

FIG. 10 shows an example (in the case of one vanishing point) of the spatial composition extraction template according to the first embodiment.

FIG. 11 shows an example (in the case of two vanishing points) of the spatial composition extraction template according to the first embodiment.

FIGS. 12A and 12B show examples (in the case of including ridge lines) of the spatial composition extraction template according to the first embodiment.

FIG. 13 shows an example (in the case of a vertical type which includes ridge lines) of the spatial composition extraction template according to the first embodiment.

FIGS. 14A and 14B show examples of a generation of synthesized three-dimensional information, according to the first embodiment.

FIG. 15 shows an example of a case where a position of a viewpoint is changed, according to the first embodiment.

FIG. 16A shows another example of the case where a position of a viewpoint is changed, according to the first embodiment. FIG. 16B shows an example of a common part between images, according to the first embodiment. FIG. 16C shows another example of the common part between images, according to the first embodiment.

FIG. 17 shows an example of a transition in an image display, according to the first embodiment.

FIGS. 18A and 18B show examples of a camera movement according to the first embodiment.

FIG. 19 shows another example of the camera movement according to the first embodiment.

FIG. 20 is a flowchart showing a flow of the process carried out by a spatial composition specification unit, according to the first embodiment.

FIG. 21 is a flowchart showing a flow of the process performed by a viewpoint control unit, according to the first embodiment.

FIG. 22 is a flowchart showing a flow of the process executed by a three-dimensional information generation unit, according to the first embodiment.

### NUMERICAL REFERENCES

100 image processing device

101 image obtainment unit

110 spatial composition template storage unit

111 spatial composition user IF unit

112 spatial composition specification unit

120 object template storage unit

121 object user IF unit

122 object extraction unit

130 three-dimensional information generation unit

131 three-dimensional information user IF unit

140 information correction user IF unit

141 information correction unit

150 three-dimensional information storage unit

151 three-dimensional information comparison unit

160 style/effect template storage unit

161 effect control unit

162 effect user IF unit

170 image generation unit

171 image display unit

180 viewpoint change template storage unit

181 viewpoint control unit

182 viewpoint control user IF unit

190 camera work setting image generation unit

201 original image

202 binarized image

301 edge-extracted image

302 spatial composition extraction example

303 spatial composition confirmation image

401 spatial composition extraction template example

402 spatial composition extraction template example

410 vanishing point

420 far front wall

501 image range example

502 image range example

503 image range example

510 vanishing point

520 magnified spatial composition extraction template example

521 magnified spatial composition extraction template example

610 object extraction example

611 depth information synthesis example

701 virtual viewing position

702 virtual viewing direction

810 depth information synthesis example

811 viewpoint change image generation example

901 vanishing point

902 far front wall

903 wall height

904 wall width

910 spatial composition extraction template

1001 vanishing point

1002 vanishing point

1010 spatial composition extraction template

1100 spatial composition extraction template

1101 vanishing point

1102 vanishing point

1103 ridge line

1104 ridge line height

1110 spatial composition extraction template

1210 spatial composition extraction template

1301 present image data

1302 past image data

1311 present image data object A

1312 present image data object B

1313 past image data object A

1314 past image data object B

1320 synthesized three-dimensional information example

1401 image position example

1402 image position example

1403 viewing position

1404 object-to-be-viewed

1411 image example

1412 image example

1501 image position example

1502 image position example

1511 image example

1512 image example

1521 common-part image example

1522 common-part image example

1600 image display transition example

1700 camera movement example

1701 start-viewing position

1702 viewing position

1703 viewing position

1704 viewing position

1705 viewing position

1706 viewing position

1707 end-viewing position

1708 camera movement line

1709 camera movement ground projection line

1710 start-viewing area

1711 end-viewing area

1750 camera movement example

1751 start-viewing position

1752 end-viewing position

1753 camera movement line

1754 camera movement ground projection line

1755 camera movement wall projection line

1760 start-viewing area

1761 end-viewing area

1800 camera movement example

1801 start-viewing position

1802 end-viewing position

### BEST MODE FOR CARRYING OUT THE INVENTION

The following describes in detail the embodiment of the present invention with reference to the diagrams. Note that the present invention is described using the diagrams in the following embodiment; however, the invention is not limited to such embodiment.

### First Embodiment

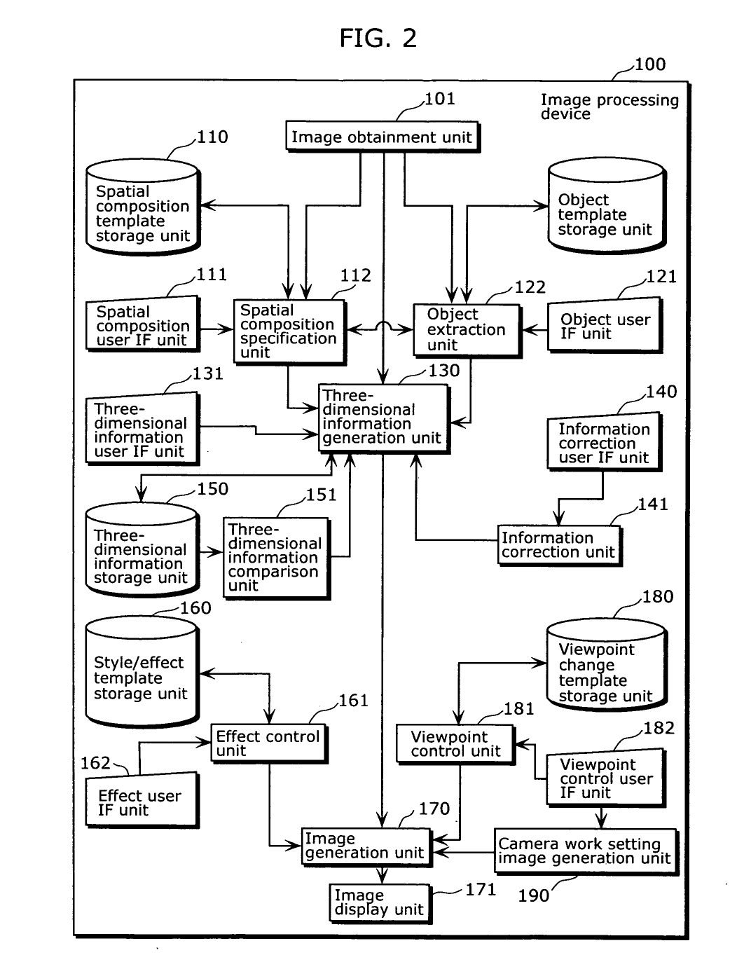

FIG. 2 is a block diagram showing a function structure of the image processing device according to the embodiment. An image processing device 100 is an apparatus which can generate three-dimensional information (also referred to as “3D information”) from a still image (also referred to as “original image”), generate a new image using the generated three-dimensional information, and present the user with a three-dimensional video. Such image processing device 100 includes: an image obtainment unit 101, a spatial composition template storage unit 110, a spatial composition user IF unit 111, a spatial composition specification unit 112, an object template storage unit 120, an object user UF unit 121, an object extraction unit 122, a three-dimensional information generation unit 130, a three-dimensional information user IF unit 131, an information correction user IF unit 140, an information correction unit 141, a three-dimensional information storage unit 150, a three-dimensional information comparison unit 151, a style/effect template storage unit 160, an effect control unit 161, an effect user IF unit 162, an image generation unit 170, an image display unit 171, a viewpoint change template storage unit 180, a viewpoint control unit 181, a viewpoint control user IF unit 182, and a camera work setting image generation unit 190.

The image obtainment unit 101, having a storage device such as a RAM and a memory card, obtains, on a frame basis, image data of an image of a still image or a moving picture via a digital camera, a scanner or the like, and performs binarization and edge extraction onto the image. It should be noted that the image obtained per frame from the obtained still image or moving picture is generically termed as “still image” hereinafter.

The spatial composition template storage unit 110 has a storage device such as a RAM, and stores a spatial composition template to be used by the spatial composition specification unit 112. “Spatial composition template” here denotes a framework composed of plural lines for representing a depth in a still image, and includes information such as a reference length in a still picture, in addition to start and end positions of each line, information indicating a position at which the lines intersect.

The spatial composition user IF unit 111, equipped with a mouse, a keyboard, and a liquid crystal panel and others, receives an instruction from the user and informs the spatial composition specification unit 112 of it.

The spatial composition specification unit 112 determines a spatial composition (hereinafter to be referred to simply as “composition”) of the obtained still image based on edge information and object information (to be mentioned later) of the still image. The spatial composition specification unit 112 also selects, as necessary, a spatial composition template from the spatial composition template storage unit 110 (and then, corrects the selected spatial composition template if necessary), and specifies a spatial composition. The spatial composition specification unit 112 may further determine or correct the spatial composition with reference to the object extracted by the object extraction unit 122.

The object template storage unit 120 has a storage device such as a RAM and a hard disk, and stores an object template or a parameter for extracting an object from the obtained original image.

The object user IF unit 121 has a mouse, a keyboard and others and selects a method (e.g. template matching, neural network, and color information, etc.) to be used for extracting an object from a still image, selects an object from among the objects presented as object candidates through the selected method, selects an object per se, corrects the selected object, adds a template, or receives a user's operation in adding a method for extracting an object.

The object extraction unit 122 extracts an object from the still image, and specifies the information regarding the object such as position, number, form and type of the object (hereinafter to be referred to as “object information”). In this case, the candidates (e.g. human, animal, building, plant, etc.) for the object to be extracted are determined beforehand. The object extraction unit 122 further refers to an object template stored in the object template storage unit 120, and extracts an object based on a correlation value between each template and the object in the still image, if necessary. The object extraction unit 122 may extract an object or correct the object, with reference to the spatial composition determined by the spatial composition specification unit 112.

The three-dimensional information generation unit 130 generates three-dimensional information regarding the obtained still image, based on the spatial composition determined by the spatial composition specification unit 112, the object information extracted by the object extraction unit 122, the instruction received from the user via the three-dimensional information user IF unit 131. Moreover, the three-dimensional information generation unit 130 is a micro computer equipped with a ROM, a RAM, and the like, and controls the whole image processing device 100.

The three-dimensional information user IF unit 131 is equipped with a mouse, a keyboard and others, and changes three-dimensional information according to user's instructions.

The information correction user IF unit 140 is equipped with a mouse, a keyboard, and the like, and receives a user's instruction and informs the information correction unit 141 of it.

The information correction unit 141 corrects the object which is extracted by mistake, or corrects the spatial composition which is erroneously specified and three-dimensional information, based on the user's instruction received via the information correction user IF unit 140. Alternatively, correction can be made based on the rules defined based on the extraction of an object, the specification of a spatial composition and a result of the generation of three-dimensional information, for example.

The three-dimensional information storage unit 150 is equipped with a storage device such as a hard disk or the like, and stores three-dimensional information which is being created and the three-dimensional information generated in the past.

The three-dimensional information comparison unit 151 compares all or part of the three-dimensional information generated in the past with all or part of the three-dimensional information which is being processed (or already processed). In the case where similarity and accordance are verified, the three-dimensional information comparison unit 151 provides the three-dimensional information generation unit 130 with the information for enriching the three-dimensional information.

The style/effect template storage unit 160 includes a storage device such as a hard disk, and stores a program, data, a style or a template which are related to arbitrary effects such as a transition effect and a color transformation which are to be added to an image to be generated by the image generation unit 170.

The effect control unit 161 adds such arbitrary effects to a new image to be generated by the image generation unit 170. A set of effects in accordance with a predetermined style may be employed so that a sense of unity can be produced throughout the whole image. In addition, the effect control unit 161 adds a new template or the like into the style/effect template storage unit 160 or edits a template which is used for reference.

The effect user IF unit 162, equipped with a mouse, a keyboard and the like, informs the effect control unit 161 of user's instructions.

The image generation unit 170 generates an image which three-dimensionally represents the still image based on the three-dimensional information generated by the three-dimensional information generation unit 130. To be more precise, the image generation unit 170 generates a new image derived from the still image, using the generated three-dimensional information. A three-dimensional image may be simplified, and a camera position and a camera direction may be displayed within the three-dimensional image. The image generation unit 170 further generates a new image using viewpoint information and display effects which are separately specified.

The image display unit 171 is a display such as a liquid crystal panel and a PDP, and presents the user with the image or video generated by the image generation unit 170.

The viewpoint change template storage unit 180 stores a viewpoint change template indicating a three-dimensional movement of a predetermined camera work.

The viewpoint control unit 181 determines a position of viewing, as a camera work. In this case, the viewpoint control unit 181 may refer to the viewpoint change template stored in the viewpoint change template storage unit 180. The viewpoint control unit 181 further creates, changes, deletes and etc. a viewpoint change template based on the user's instruction received via the viewpoint control user IF unit 182.

The viewpoint control user IF unit 182, equipped with a mouse, a keyboard and etc., informs the viewpoint control unit 181 of the user's instruction regarding control of a viewing position.

The camera work setting image generation unit 190 generates an image when viewed from a present position of the camera so that the image is referred to by the user in determining a camera work.

Note that all the above-mentioned functional components (i.e. those named by “- - - unit” in FIG. 2) are not necessary as the components of the image processing device 100 according to the embodiment are necessary, and the image processing device 100 can be surely composed by selecting the functional elements, if necessary.

The following describes in detail each of the functions in the image processing device 100 structured as described above. Here is a description of the embodiment in generating three-dimensional information from an original still image (hereinafter to be referred to as “original image”), and further generating a three-dimensional video.

First, the spatial composition specification unit 112 and the functions of the peripheral units are described.

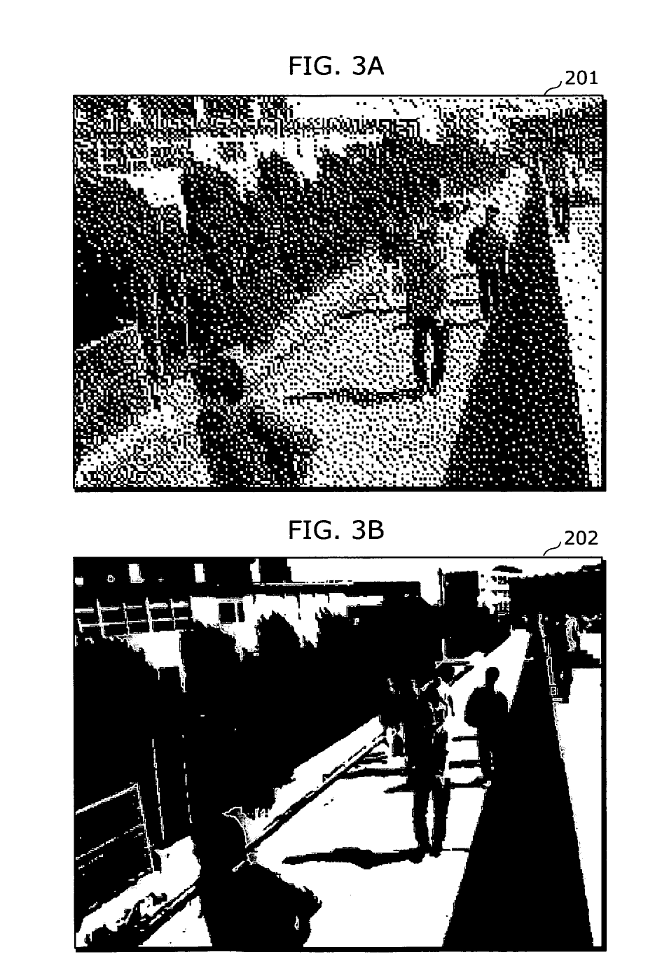

FIG. 3A shows an example of an original image according to the embodiment. FIG. 3B shows an example of a binarized image generated by binarizing the original image.

In order to determine a spatial composition, it is important to roughly extract a spatial composition. Firstly, a main spatial composition (hereinafter to be referred to as “outline spatial composition”) is specified in the original image. Here, an embodiment in which “binarization” is performed in order to extract an outline spatial composition, and then, fitting based on template matching is performed is described. The binarization and the template matching are merely the examples of the method for extracting an outline spatial composition, and another arbitrary method can be used for the extraction of an outline spatial composition. Moreover, a detailed spatial composition may be directly extracted without extracting an outline spatial composition. Note that an outline spatial composition and a detailed spatial composition are to be generically termed as “spatial composition” hereinafter.

The image obtainment unit 101 firstly obtains a binarized image 202 as shown in FIG. 3B by binarizing an original image 201, and then, obtains an edge extracted image from the binarized image 202.

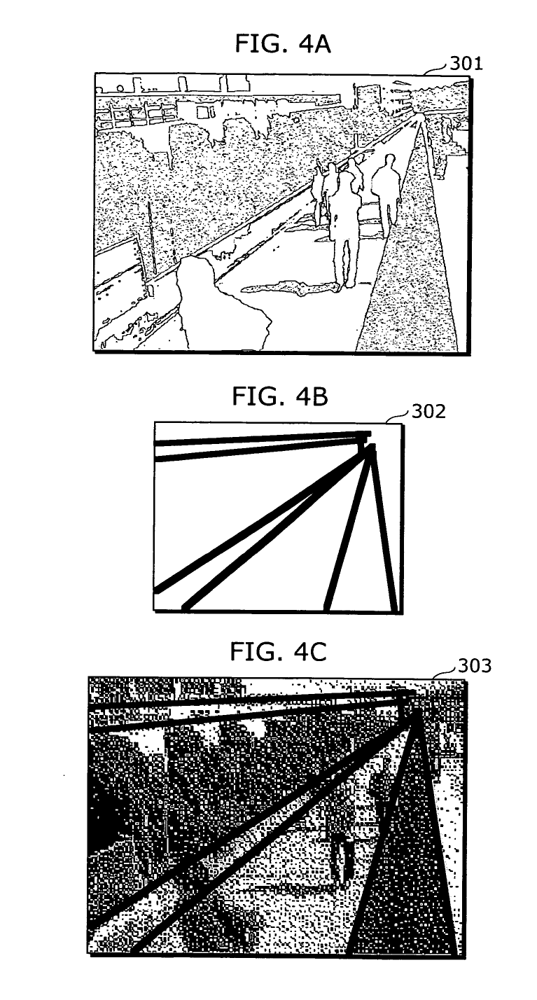

FIG. 4A shows an example of edge extraction according to the embodiment. FIG. 4B shows an example of the extraction of a spatial composition. FIG. 4C shows an example of a display for verifying the spatial composition.

After the binarization, the image obtainment unit 101 performs edge extraction onto the binarized image 202, generates an edge extracted image 301, and outputs the generated edge extracted image 301 to the spatial composition specification unit 112 and the object extraction unit 122.

The spatial composition specification unit 112 generates a spatial composition using the edge extracted image 301. More precisely, the spatial composition specification unit 112 extracts, from the edge extracted image 301, at least two straight lines which are not paralleled to each other, and generates a “framework” by combining these lines. Such “framework” is a spatial composition.

The spatial composition extraction example 302 shown in FIG. 4B is an example of the spatial composition generated as described above. The spatial composition specification unit 112 corrects the spatial composition of a spatial composition verification image 303 so that the spatial composition matches with what is displayed in the original image, according to the user's instruction received via the spatial composition user IF unit 111. Here, the spatial composition verification image 303 is an image for verifying whether or not the spatial composition is appropriate, and is also an image generated by synthesizing the original image 201 and the spatial composition extraction example 302. Note that in the case where the user makes correction, or applies another spatial composition extraction, or adjusts the spatial composition extraction example 302, the spatial composition specification unit 112 follows the user's instruction received via the spatial composition user IF unit 111.

Note that the embodiment describes that the edge extraction is carried out by performing “binarization” to an original image. However, the present invention is not limited to such method, and the edge extraction can be surely performed using an existing image processing method or a combined method of the existing method and the method described above. The existing image processing methods use color information, luminous information, orthogonal transformation, wavelet transformation, or various types of one-dimensional or multidimensional filters. The present invention; however, is not restricted to these methods.

Note also that a spatial composition does not necessarily have to be generated from an edge extracted image as described above. In order to extract a space composition, “a spatial composition extraction template” which is a sample of spatial composition that is previously prepared may be used.

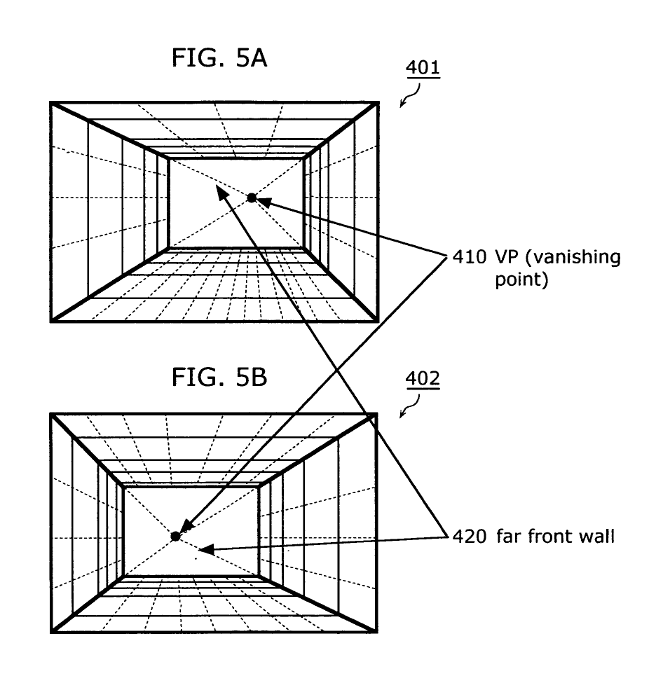

FIGS. 5A and 5B are examples of such spatial composition extraction template. The spatial composition specification unit 112 select, as necessary, the spatial composition extraction template as shown in FIGS. 5A and 5B from the spatial composition template storage unit 110, and performs matching by synthesizing the template and the original image 201, so as to be able to determine a final spatial composition.

The following describes an example of determining a spatial composition using a spatial composition extraction template. Nevertheless, a spatial composition may be estimated using edge information, and placement information (information indicating what is placed where) of an object, without using the spatial composition extraction template. It is further possible to determine a spatial composition by arbitrarily combining the existing image processing methods such as segmentation (region segmentation), orthogonal transformation or wavelet transformation, color information and luminous information. One of such examples is to determine a spatial composition based on a direction toward which a boundary of each segmented region faces. Also, meta information (arbitrary tag information such as EXIF) attached to a still image may be used. It is possible to use arbitrary tag information, for example, “judge on whether or not any vanishing points (to be mentioned later) are included in the image, based on depth of focus and depth of field” in order to extract a spatial composition.

It is also possible to use the spatial composition user IF unit 111 as an interface which performs all kinds of input and output desired by the user such as input, correction or change of template, input, correction or change of spatial composition information per se.

In FIGS. 5A and 5B, a vanishing point VP410 is shown in each spatial composition extraction template. Although this example shows the case of only one vanishing point, the number of vanishing points may be more than one. A spatial composition extraction template is not limited to those shown in FIGS. 5A and 5B, as will be mentioned later, and is a template adaptable to any arbitrary image which has depth information (or perceived to have depth information).

In addition, it is also possible to generate a similar arbitrary template from one template by moving the position of the vanishing point as in the case where a spatial composition extraction template 402 is generated from a spatial composition extraction template 401. In some cases, there may be a wall on the way to reach the vanishing point. In such case, it is possible to set a wall (in a recessing direction) within the spatial composition extraction template, as in the case of a far front wall 420. Needless to say, it is possible to move a distance to the far front wall 420 in a recessing direction as is the case of the vanishing point.

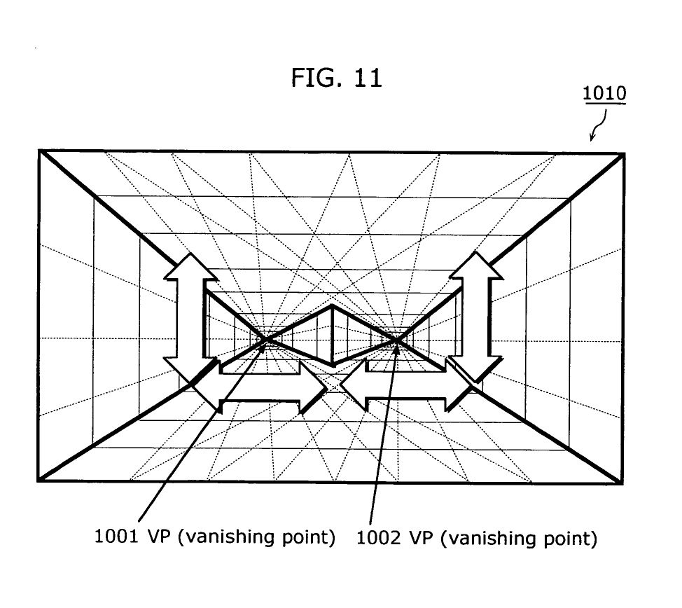

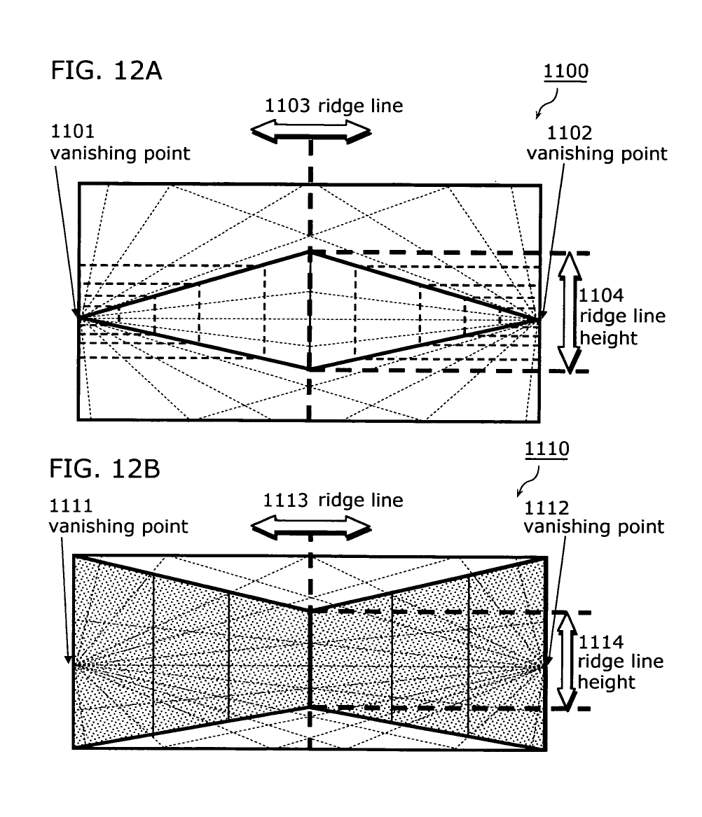

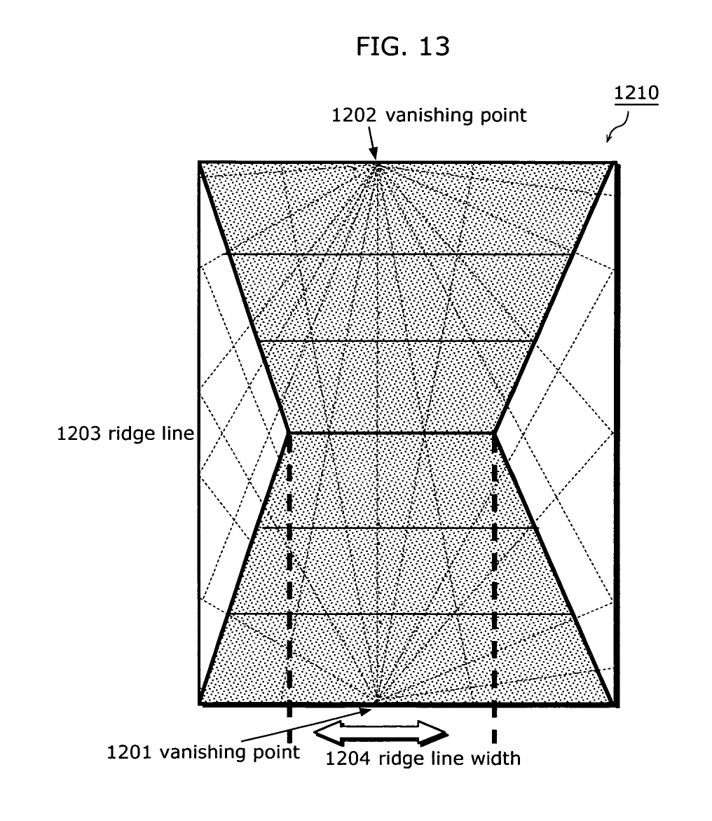

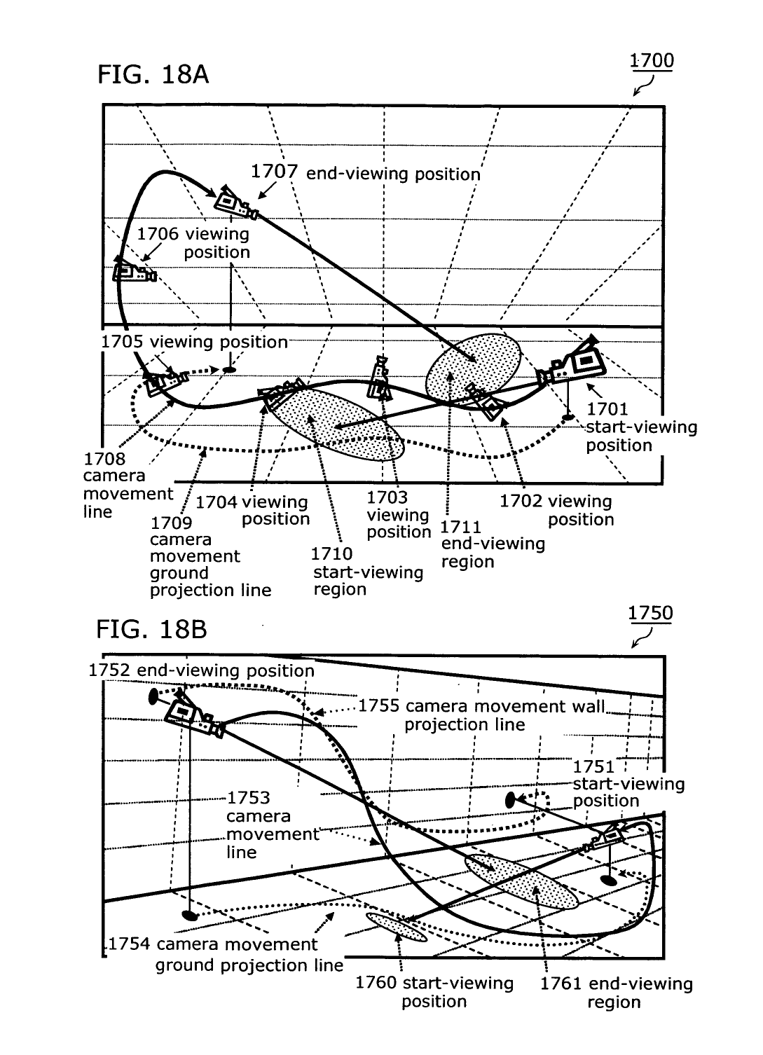

Besides the spatial position extraction templates 401 and 402 with one vanishing point, the other examples of such spatial composition extraction template may be the case where the number of vanishing points are two, as follows: the case where two vanishing points (vanishing points 1001 and 1002) are presented as shown in a spatial composition extraction template example 1010 in FIG. 11; the case where walls of two different directions intersect with each other (it can be said that this is also the case of having two vanishing points) as shown in a spatial composition extraction template 1110 in FIG. 12; the case where two vanishing points are vertically placed as shown in a spatial composition extraction template 1210 in FIG. 13; the case where vanishing points form a line as a horizontal line (horizon) shown in a camera movement example 1700 in FIG. 18A; and the case where vanishing points are placed outside an image range as shown in a camera movement example 1750 in FIG. 18B. Thus, it is possible to arbitrarily use the spatial composition which is generally used in the fields of drawing, CAD and design.

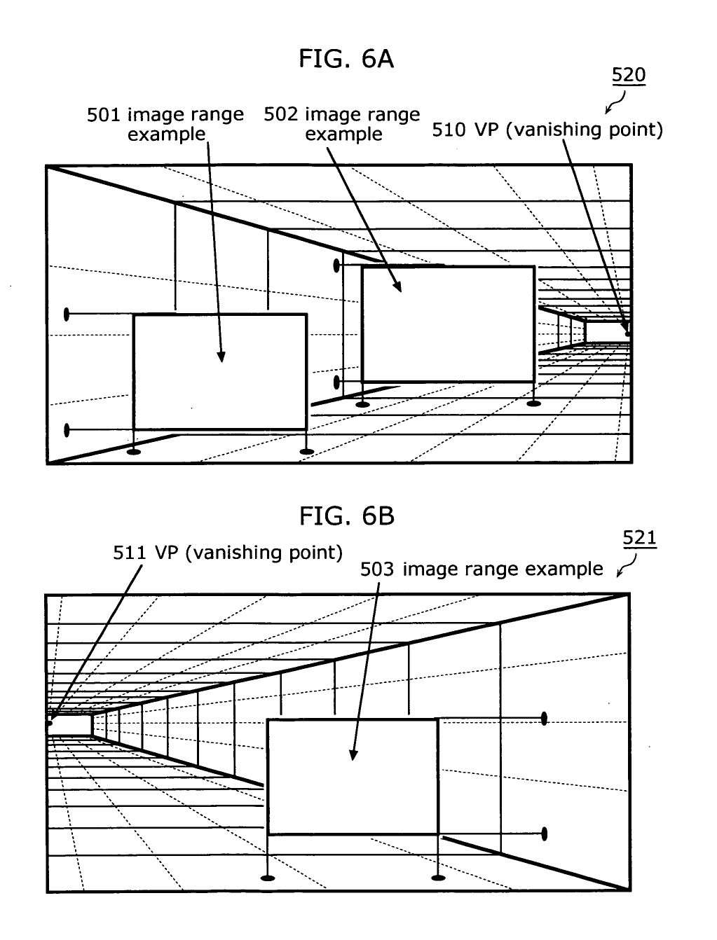

Note that in the case where the vanishing points are placed outside the range of image, as shown in the camera movement example 1750 in FIG. 18B, it is possible to use a magnified spatial composition extraction template as shown in the magnified spatial composition extraction templates 520 and 521 shown in FIG. 6. In this case, it is possible to set vanishing points for the image whose vanishing points are located outside the image, as shown in the image range examples 501, 502 and 503 shown in FIGS. 6A and 6B.

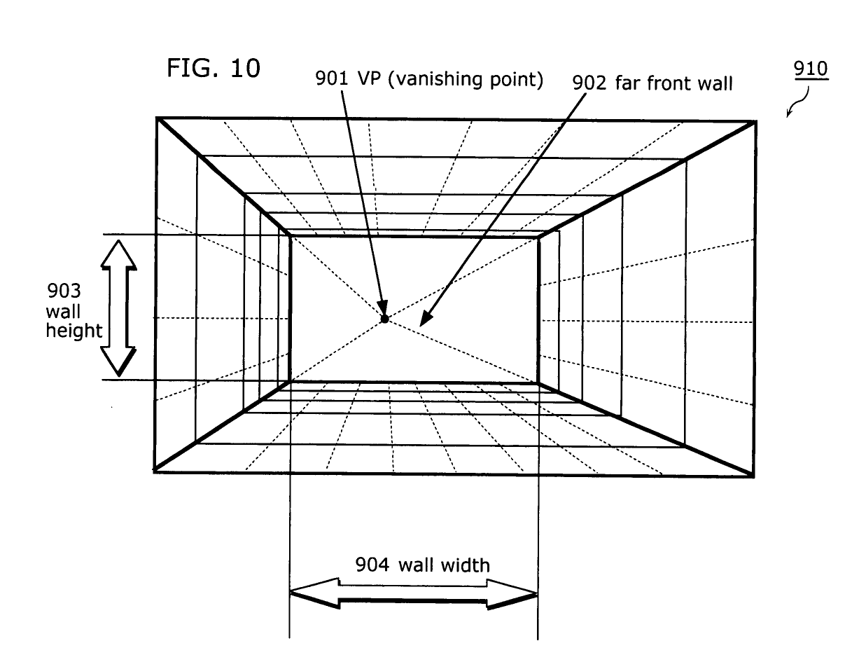

It should be also noted that, for the spatial composition extraction templates, it is possible to freely change an arbitrary parameter regarding spatial composition such as positions of vanishing points. For example, a spatial composition extraction template 910 in FIG. 10 is flexibly adaptable to various types of spatial compositions by changing a position of the vanishing point 910, a wall height 903 and a wall width 904 of a far front wall 902. Similarly, the spatial composition extraction template 1010 in FIG. 11 shows the case of arbitrarily moving the position of the two vanishing points (vanishing points 1001 and 1002). The parameters of spatial composition to be changed are surely not limited to vanishing points and a far front wall, and any arbitrary parameters within the spatial composition such as a lateral plane, a ceiling plane and a far front wall plane. In addition, arbitrary states regarding phase such as angles and spatial placement positions of these planes may be used as sub-parameters. Also, the method of changing parameters is not limited to vertical and horizontal direction, and variations such as rotation, morphing, and affine transformation may be performed.

Such transformation and change may be arbitrarily combined according to a specification of the hardware to be used in the image processing device 100 or a demand in terms of user interface. For example, in the case of installing a CPU of a relatively low specification, it is conceivable to reduce the number of spatial composition extraction templates to be provided beforehand, and select, through template matching, the closest spatial composition extraction template which has the least transformation and change among them. In the case of using the image processing device 100 equipped with a relatively abundant number of memory devices, numerous templates may be prepared beforehand and held in a storage device, so that the time required for transformation and change can be reduced. Also, it is possible to classify, in a hierarchical manner, the spatial composition extraction templates to be used, so that speedy and accurate matching can be performed (templates can be placed just the same as data is placed on a database for high-speed retrieval).

Note that the spatial composition extraction template examples 1100 and 1110 in FIG. 12 show examples of changing positions of ridge lines (1103 and 1113), heights of ridge lines (ridge line heights 1104 and 1114) besides vanishing points and a far front wall. Similarly, FIG. 13 shows vanishing points (1202 and 1201) and ridge line (1203) and a ridge line width (1204) in the case of vertical spatial composition.

The parameters regarding such spatial composition may be set by user's operations (specification, selection, correction and registration are some of the examples to be raised and the operations shall not be limited to them) via the spatial composition user IF unit 111.

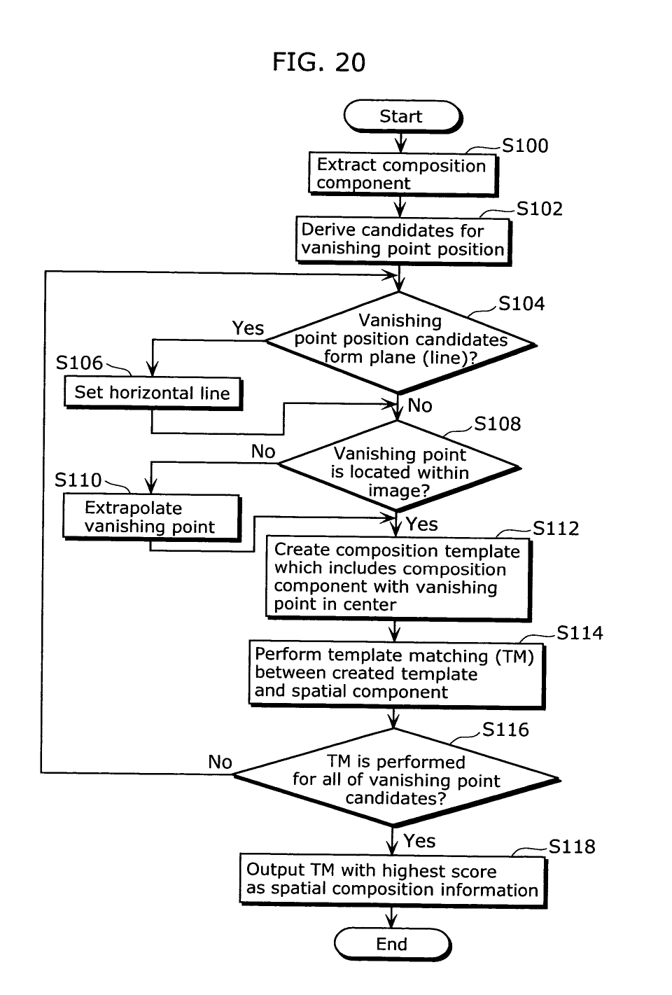

FIG. 20 is a flowchart showing a flow of the processing up to the specification of a spatial composition, operated by the spatial composition specification unit 112.

First, the spatial composition specification unit 112 obtains the edge extracted image 301 from the image obtainment unit 101, and extracts an element (e.g. unparallely linear object) of the spatial composition, from the edge extracted image 301 (S100).

The spatial composition specification unit 112 then calculates candidates for the positions of vanishing points (S102). In the case where the calculated candidates for vanishing points are not points (Yes in S104), the spatial composition specification unit 112 sets a horizontal line (S106). In the further case where the positions of the vanishing point candidates are not placed within the original image 201 (No in S108), vanishing points are extrapolated (S110).

Then, the spatial composition specification unit 112 creates a spatial composition template which includes the elements composing the spatial composition with the vanishing points in the center (S112), and performs template matching (referred to simply as “TM”) between the created spatial composition template and the spatial composition components (S114).

The spatial composition specification unit 112 performs the above process (S104-S116) onto all the vanishing point candidates and eventually specifies the most appropriate spatial composition (S118).

The following describes the functions of the object extraction unit 122 and the peripheral units.

The method used in the existing image processing method or image recognition method can be arbitrarily used as the method for extracting an object. For example, a human object may be extracted based on template matching, neural network and color information. Through segmentation or region segmentation, it is also possible to regard a segment or segmented region as an object. In the case of a moving picture or one still image of the still images in sequence, it is possible to extract an object from forward and backward frame images. The extraction method and extraction target are surely not to be limited to the above examples, and shall be arbitrary.

The templates and parameters intended for object extraction as described above are stored into the object template storage unit 120 so that they can be read out for use according to the circumstances. Alternatively, new templates or parameters can be inputted into the object template storage unit 120.

The object user IF unit 121 selects a method of extracting an object (template matching, neural network and color information), or the object candidate presented as a candidate, or an object per se, and provides an interface for carrying out all the operations desired by the user such as correction of results, addition of templates and object extraction methods.

The following describes the functions of the three-dimensional information generation unit 130 and the peripheral units.

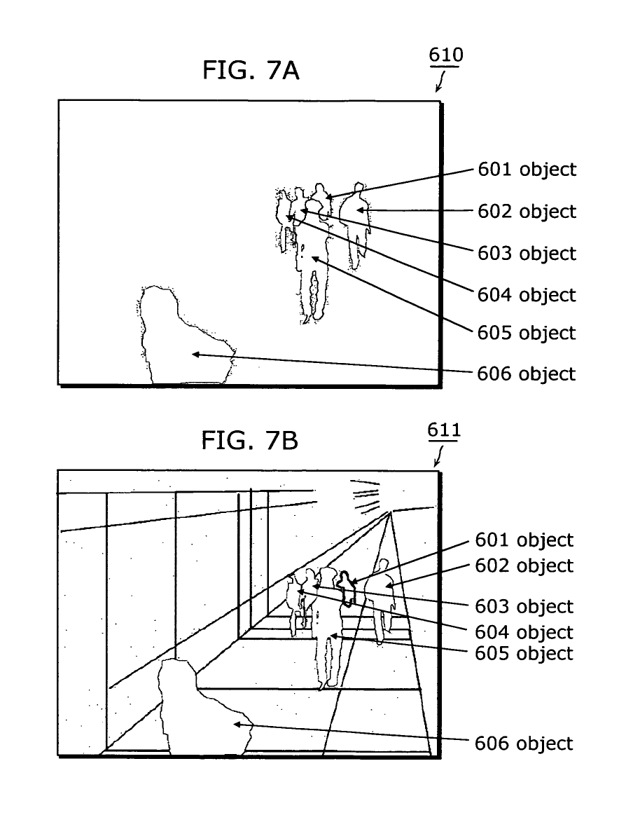

FIG. 7A shows extracted objects while FIG. 7B shows an example of an image generated by synthesizing the extracted objects and the determined spatial composition. In the object extraction example 610, objects 601, 602, 603, 604, 605 and 606 are extracted as main human images out of the original image 201. The depth information synthesis example 611 is generated by synthesizing the respective objects and the spatial composition.

The three-dimensional information generation unit 130 can generate three-dimensional information by placing the extracted objects in the spatial composition, as described above. Note that the three-dimensional information can be inputted and corrected according to the user's instruction received via the three-dimensional information generation user IF unit 131.

The image generation unit 170 sets a new virtual viewpoint in a space having the three-dimensional information generated as described above, and generates an image that is different from an original image.

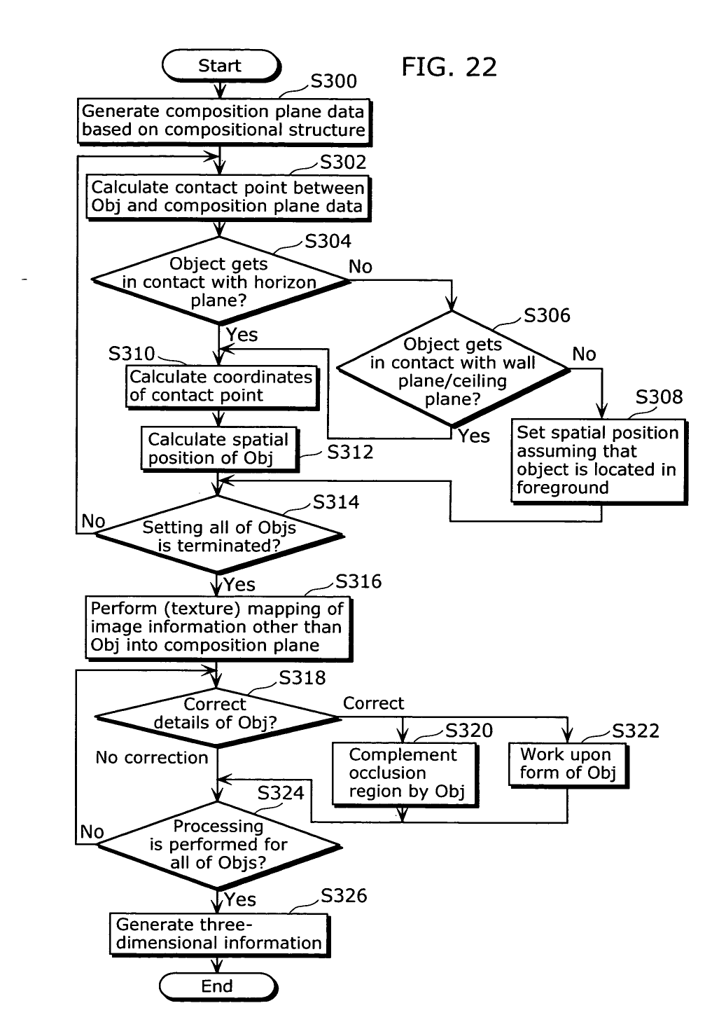

FIG. 22 is a flowchart showing a flow of the processing carried out by the three-dimensional information generation unit 130.

First, the three-dimensional information generation unit 130 generates data regarding a plane in a spatial composition (hereinafter to be referred to as “composition plane data”), based on the spatial composition information (S300). The three-dimensional information generation unit 130 then calculates a contact point between the extracted object (also referred to as “Obj”) and a composition plane (S302). In the case where there is no contact between the object and a horizontal plane (No in S304) and where there is no contact between the object and a lateral plane or a ceiling plane (No in S306), the three-dimensional information generation unit 130 sets a spatial position of the object assuming that the object is located in the foreground (S308). In any other cases, the three-dimensional information generation unit 130 calculates coordinates of a contact point (S310), and derives a spatial position of the object (S312).

In the case of performing the above processing onto all the objects (Yes in S314), the three-dimensional information generation unit 130 performs mapping of image information except for the object information onto the spatial composition plane (S316).

The three-dimensional information generation unit 130 further allows the information correction unit 141 to insert the corrections made with regard to the objects (S318-S324), and completes the generation of the three-dimensional information (S326).

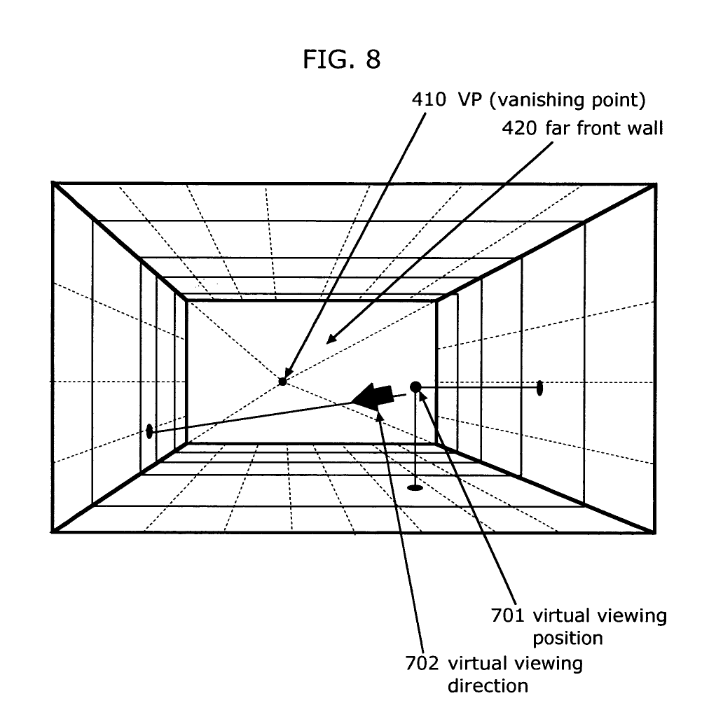

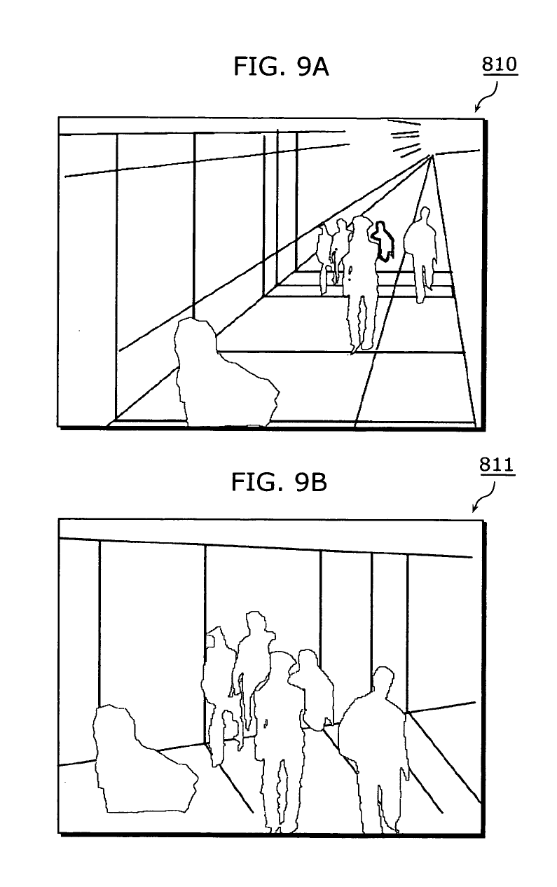

The method for setting a position of a virtual viewing position is described with reference to FIG. 8. First, a virtual viewing position 701 is considered as a viewing position in a space, and a virtual viewing direction 702 is set as a viewing direction. Considering the virtual viewing position 701 and the virtual viewing direction 702 in view of a depth information synthesis example 810 (the same as the depth information synthesis example 611) in FIG. 9, for, in the case of setting the virtual viewing position 701 as a viewing position and the virtual viewing direction 702 as a viewing direction for the depth information synthesis example 810 viewed from front (i.e., in the case of seeing the example 810 from a lateral direction), it is possible to generate an image as shown in a viewpoint change image generation example 811.

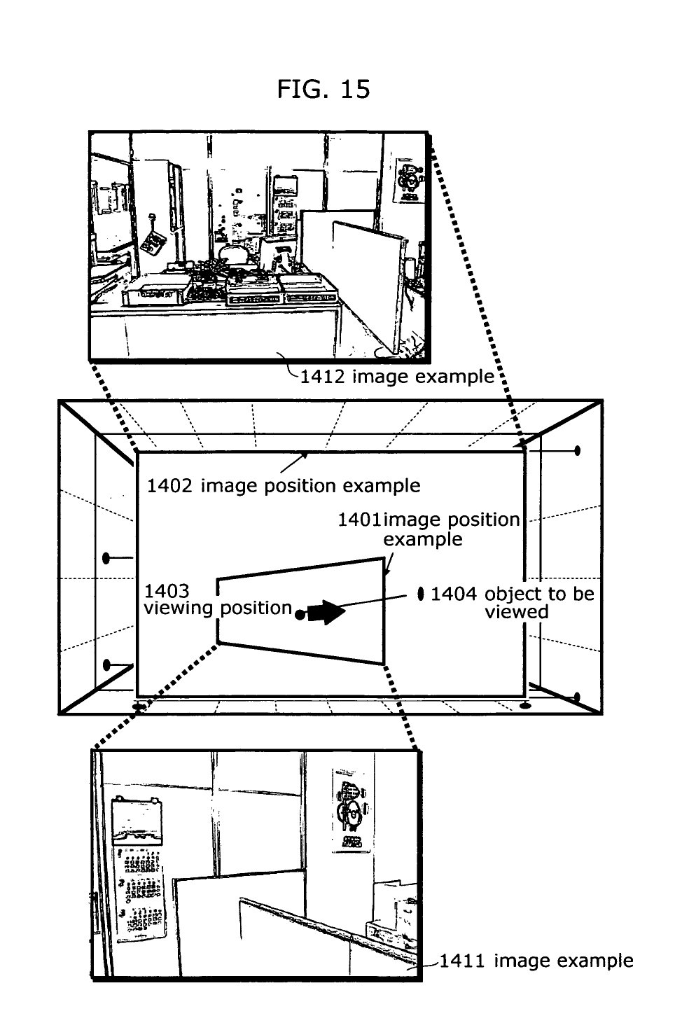

Similarly, FIG. 15 shows an image example assuming a viewing position and a viewing direction for an image having three-dimensional information. An image example 1412 is an image example in the case of using an image position example 1402. The image example 1411 is an image example in the case of using an image position example 1401. As for the image position example 1401, a viewing position 1403 and an object-to-be-viewed 1404 are expressed, as samples of the viewing position and the object-to-be-viewed.

FIG. 15 here is used as an example in the case of generating an image after setting a virtual viewpoint, from an image having three-dimensional information. Note that the image example 1412 is a still image used for the obtainment of three-dimensional information (spatial information) and it can be said that the image example 1412 is an image in the case of setting the viewing position 1403, the object-to-be-viewed 1404 for the three-dimensional information extracted from the image example 1412.

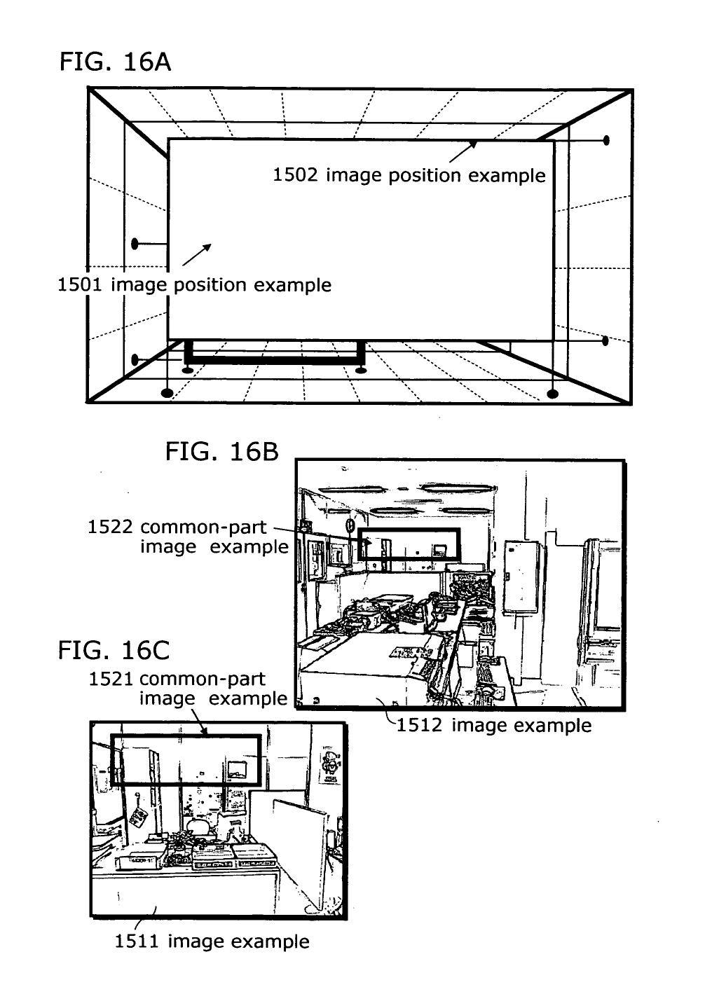

Similarly, FIG. 16 shows an image example 1511 and an image example 1512 as the image examples respectively corresponded to an image position example 1501 and an image position example 1502. In some case, there are overlaps in part between the image examples. For instance, a common-part image 1521 and a common-part image 1521 are such overlapping part.

Note that it is possible to generate an image while externally and internally performing viewing, focusing, zooming, panning and the like or by performing transition or effects onto three-dimensional information, as camera work effects for generating a new image.

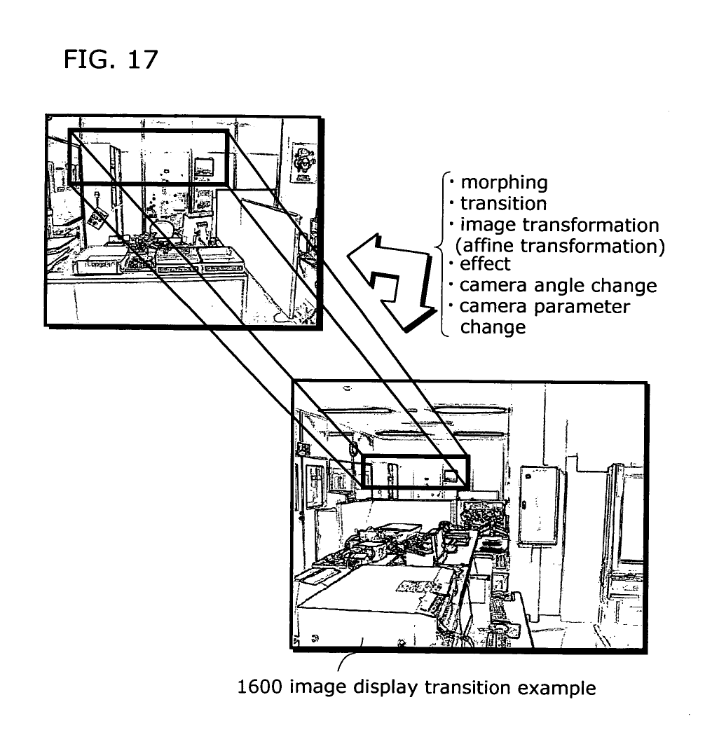

Furthermore, it is also possible not only to generate a moving picture or still images as generated by merely shooting a three-dimensional space with a virtual camera, but also to join such moving picture or still images (or a mixture of a moving picture and still images) by camera work effects, while corresponding the common part detected when still images are cut out, as can be seen in the common-part images 1521 and 1521. In this case, it is possible to join the common corresponding points and corresponding areas using morphing and affine transformation, which has not been conceived as possible with the conventional art. FIG. 17 shows an example of displaying images having a common part (i.e. a part indicated by a solid frame) by transiting the images by means of morphing, transition, image transformation (e.g. affine transformation), effects, change in camera angle, and change in camera parameter. It is easily possible to specify a common part from three-dimensional information. Conversely, it is possible to set a camera work so that images have a common part.

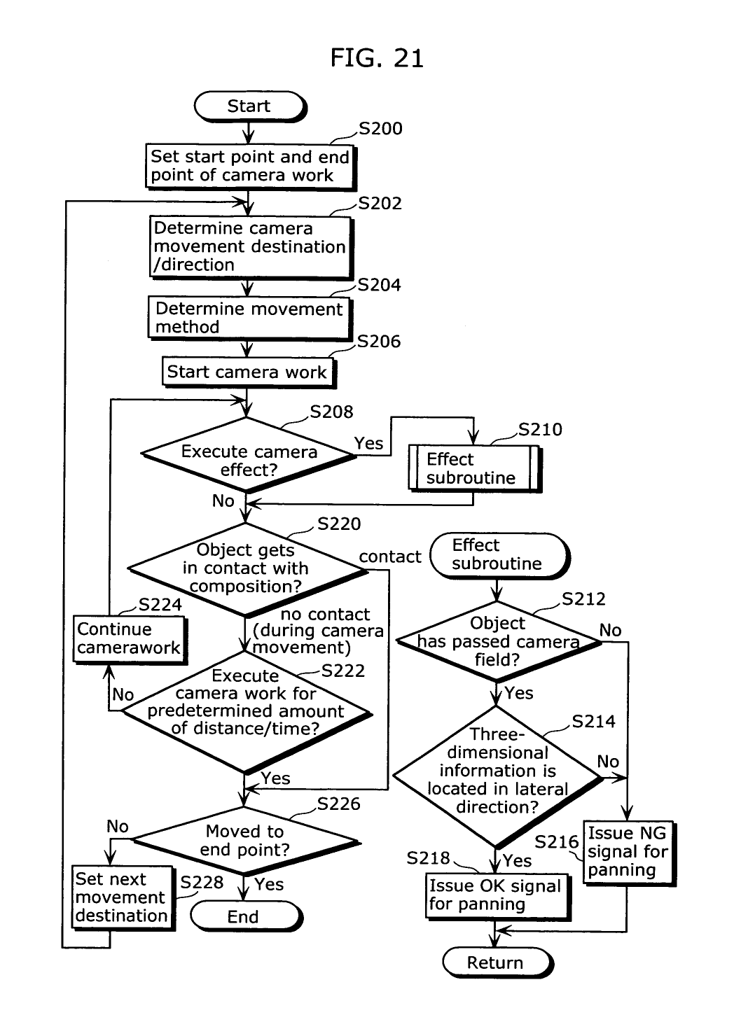

FIG. 21 is a flowchart showing a flow of the processing carried out by the viewpoint control unit 181, as described above.

The viewpoint control unit 181 firstly sets a start point and an end point of a camera work (S200). In this case, the start point is set to the position near the foreground of a virtual space while the end point is set at the point which is closer to a vanishing point with respect to the start point. For the setting of the start point and the end point, a predetermined database may be used.

Then, the viewpoint control 181 determines a moving destination and a moving direction of the camera (S202), and determines a moving method (S204). For example, the camera moves in the direction toward the vanishing point, passing near each of the objects. The camera may move not only linearly but also spirally, and the speed of the camera may be changed during the move.

The viewpoint control unit 181 actually moves the camera for a predetermined amount of distance (S206-S224). In the case of executing an effect such as panning during the move (Yes in S208), the viewpoint control unit 181 carries out a predetermined effect subroutine (S212-S218).

In the case where the camera might come in contact with a spatial composition per se (“contact” in S220), the viewpoint control unit 181 sets the next moving destination (S228), and repeats the same processing as described above (S202-S228).

It should be noted that when the camera moves to the end point, the viewpoint control unit 181 terminates the camera work.

It may be a repetition of what is already described above; however, predetermined viewpoint change templates may be preparedly stored in a database for the camera work regarding the image generation, as performed by the viewpoint change template storage unit 108. Also, new viewpoint change templates may be added in the viewpoint change template storage unit 108 or a viewpoint change template may be edited for use. Moreover, a viewing position may be determined or a viewpoint change template may be created, edited, added or deleted, based on an user's instruction via the viewpoint control user IF unit 182.

Also, predetermined effect/style templates may be preparedly stored into a database for the effects regarding the image generation, as in the case of the effect/style template storage unit 160. A new effect/style template may be added into the effect/style template storage unit 160, or an effect/style template can be edited for use. It is also possible to determine a viewing position or create, edit, add or delete an effect/style template, according to the user's instruction via the effect user IF unit 162.

Note that, in the setting of camera work, it is possible to take a position of an object into account and set an arbitrary camera work which is dependent on an object, e.g., the camera is set along the object, or closes up the object, or moves around the object. It goes without saying that such object-dependent image creation applies not only to a camera work but also to camera effects.

Similarly, it is also possible to consider a spatial composition in the setting of a camera work. The process which takes into consideration the common part as described above is an example of a camera work or an effect which utilizes both a spatial composition and an object. Regardless of whether the image to be generated is a moving picture or a still image, it is possible to use any of the existing camera work, camera angle, camera parameter, image transformation, and transition, utilizing a spatial composition and an object.

FIGS. 18A and 18B show examples of a camera work. A camera movement example 1700 in FIG. 18A showing a trace of a camera work presents the case where a virtual camera shooting is commenced from a start-viewing position 1701 and the camera moves along a camera movement line 1708. The camera work starts from a viewing position 1702, passes viewing positions 1703, 1704, 1705 and 1706, and ends at an end-viewing position 1707. A start-viewing region 1710 is shot at the start-viewing position 1701 while an end-viewing region 1711 is shot at the end-viewing position 1707. The camera movement projected on a plane corresponding to the ground during the move is a camera movement ground projection line 1709.

Similarly, in the case of the camera movement example 1750 shown in FIG. 18B, the camera moves from a start-viewing position 1751 to an end-viewing position 1752, and shots a start-viewing region 1760 and an end-viewing region 1761. A camera movement line 1753 shows a pattern of how the camera moves during such movement. The traces generated by projecting the camera movement line 1753 on the ground and the wall respectively are presented by a camera movement ground projection line 1754 and a camera movement wall projection line 1755.

It is surely possible to generate an image (the image surely can be a moving picture, still images or a mixture of the both) in an arbitrary timing in which the camera moves along the camera movement line 1708 and the camera movement line 1753.

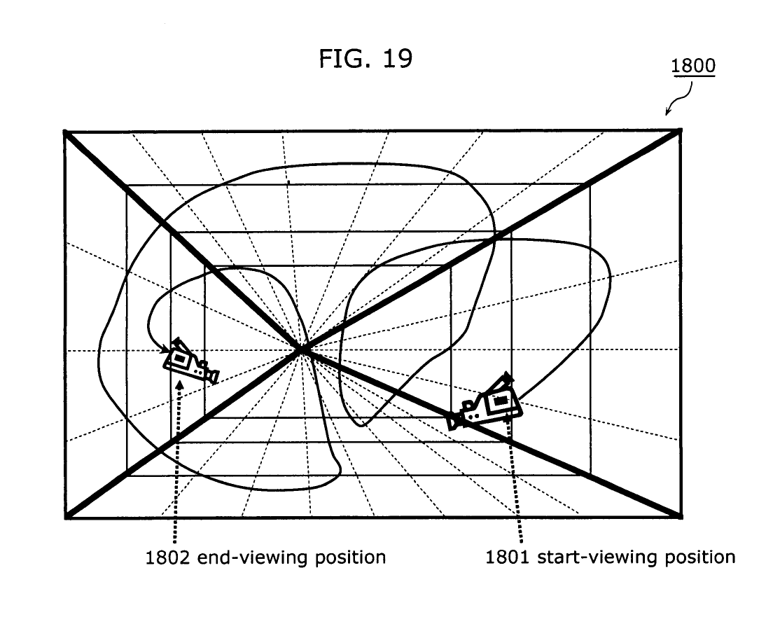

The camera work setting image generation unit 190 can generate an image viewed from the present camera position and present the user with the image, so that it helps the user in determining a camera work. An example of such image generation is shown in a camera image generation example 1810 in FIG. 18. In FIG. 19, an image generated by shooting a shooting range 1805 from a present camera position 1803 is presented as a present camera image 1804.

It is possible to present, via the viewpoint control user IF unit 182, the user with a sample three-dimensional information and an object included therein, by moving the camera as shown in the camera movement example 1800.

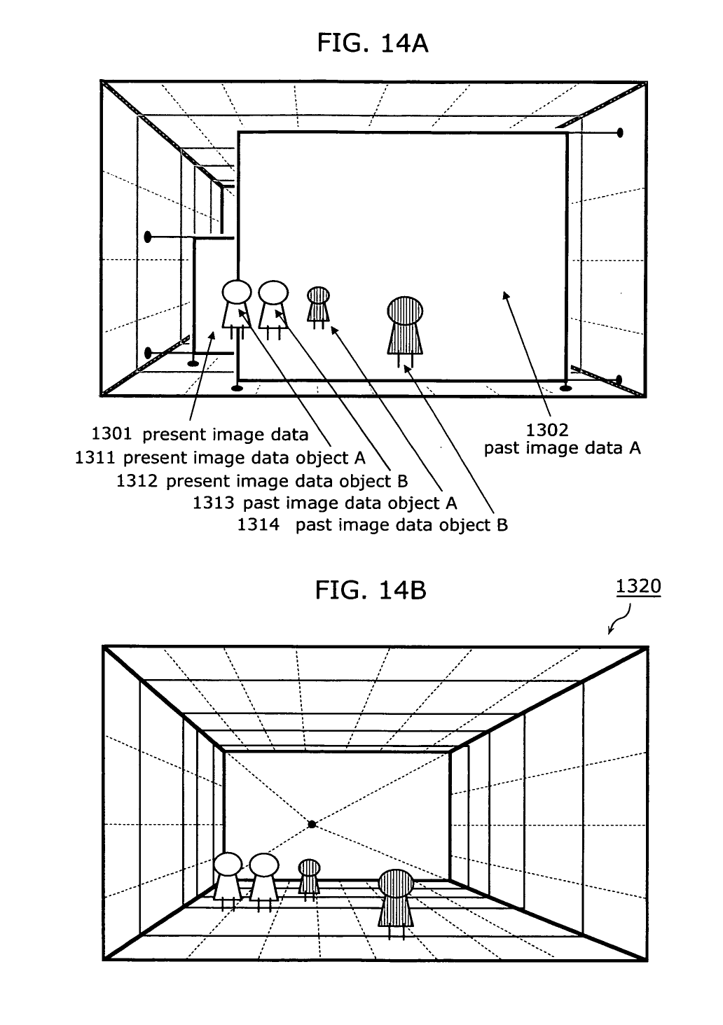

Moreover, the image processing device 100 can synthesize plural pieces of generated three-dimensional information. FIGS. 14A and 14B show examples of the case where plural pieces of three-dimensional information are synthesized. In FIG. 14A, a present image data object A1311 and a present image data object B1312 are shown within a present image data 1301, while a past image data object A1313 and a past image data object B1314 are shown within a past image data 1302. In this case, it is possible to synthesize two image data in the same three-dimensional space. A synthesis example of such case is a synthesis three-dimensional information example 1320 shown in FIG. 14B. The images may be synthesize from an element common to plural original images. Totally different original image data may be synthesized, or a spatial composition may be changed if necessary.

Note that the “effects” employed in the embodiment denotes the effects generally performed to an image (still image and moving picture). The examples of such effects are a general nonlinear image processing method as well as the effects which are to be provided (or can be provided) at the time of shooting and can be performed according to. a change in a camera work, a camera angle, camera parameters. The effects also include a processing executable by general digital image processing software or the like. Furthermore, a placement of music and sound effects in accordance with an image scene also falls into the category of such effects. In the case where the effect included in the definition of effects, such as a camera angle, and another term are cited as “effects”, the included effect is to be emphasized, and it should be clearly stated that this shall not narrow down the category of the effects.

It should be also noted that, in the case where an object is extracted from a still image, information regarding the thickness of the extracted object may be missing, in some cases. In such case, it is possible to set an arbitrary value as the thickness of the object based on depth information (any method may be employed such as calculating a relative size of the object based on the depth information, and setting an arbitrary thickness based on the calculated size).

Also, note that templates may be prepared beforehand so as to recognize what an object is, and use the result of the recognition for setting the thickness of the object. For example, in the case where an object is recognized as an apple, the thickness of the object is set to be the thickness of an apple, and in the case where an object is recognized as a vehicle, the thickness of the object is set to be the thickness of a vehicle.

Moreover, vanishing points may be set as an object. An object which actually is virtual may be processed as a real object.

Furthermore, a masked image obtained by masking an object may be generated for an extraction of the object.

when the extracted object is mapped into three-dimensional information, the object may be placed again in an arbitrary position within the depth information. The extracted object should not be necessarily mapped into an exact position indicated by the original image data, and may be placed again in an arbitrary position such as a position at which effects can be easily performed or a position at which data processing can be easily performed.

When an object is extracted or mapped into three-dimensional information, or an object included in the three-dimensional information is processed, information representing the rear face of the object may be appropriately provided. In an assumable case where information representing the rear face of the object cannot be obtained from an original image, the rear face information may be set based on front face information (e.g. copying the image information representing the front face of the object (information representing texture and polygon in terms of three-dimensional information) onto the rear face of the object. The rear face information may be surely set with reference to other objects or other spatial information. Moreover, the information to be provided regarding the rear face, such as shading, display in black, presentation of an object as if the object does not exist when viewed from the back, can be arbitrarily provided. In order that an object and its background appear to be smooth, any smoothing processing (e.g. blur the boundary) may be performed.

The camera parameters can be changed based on the position of the object which is three-dimensionally placed as spatial information. For example, in-focus information (out-of-focus information) may be generated, at the time of image generation, based on a camera position/depth derived from a position of the object and a spatial composition, so that an image with perspective is generated. In such case, only the object or both the object and its periphery may be out of focus. Furthermore, the image data management device 100 according to the first embodiment has a structure made up of separate functions such as the spatial composition user IF unit 111, the object user IF unit 121, the three-dimensional information user IF unit 131, the information correction user IF unit 140, the effect user IF unit 162, and the view point control user IF unit 182; however, the structure may have one IF unit including all the functions of the respective IF units mentioned above.

### INDUSTRIAL APPLICABILITY

The present invention is useful as an image processing device which generates a three-dimensional image from a still image stored in a micro computer, a digital camera or a cell phone equipped with a camera.

1. An image processing device which generates three-dimensional information from a still image, said image processing device comprising:
an image obtainment unit operable to obtain a still image;
an object extraction unit operable to extract an object from the obtained still image;
a spatial composition specification unit operable to specify, using a characteristic of the obtained still image, a spatial composition representing a virtual space which includes a vanishing point; and
a three-dimensional information generation unit operable to determine placement of the object in the virtual space by associating the extracted object with the specified spatial composition, and to generate three-dimensional information regarding the object based on the placement of the object.

2. The image processing device according to claim 1, further comprising:
a viewpoint control unit operable to move a position of a camera, assuming that the camera is set in the virtual space;
an image generation unit operable to generate an image in the case where an image is shot with the camera from an arbitrary position; and
an image display unit operable to display the generated image.

3. The image processing device according to claim 2,
wherein said viewpoint control unit is operable to control the camera to move within a range in which the generated three-dimensional information is located.

4. The image processing device according to claim 2,
wherein said viewpoint control unit is further operable to control the camera to move in a space in which the object is not located.

5. The image processing device according to claim 2,
wherein said viewpoint control unit is further operable to control the camera to shoot a region in which the object indicated by the generated three-dimensional information is located.

6. The image processing device according to claim 2,
wherein said viewpoint control unit is further operable to control the camera to move in a direction toward the vanishing point.

7. The image processing device according to claim 2,
wherein said viewpoint control unit is further operable to control the camera to move in a direction toward the object indicated by the generated three-dimensional information.

8. The image processing device according to claim 1, wherein:
said object extraction unit is operable to specify two or more linear objects which are unparalleled to each other from among the extracted objects; and
said spatial composition specification unit is further operable to estimate a position of one or more vanishing points by extending the specified two or more linear objects, and to specify the spatial composition based on the specified two or more linear objects and the estimated position of the one or more vanishing points.

9. The image processing device according to claim 8,
wherein said spatial composition specification unit is further operable to estimate the vanishing point outside the still image.

10. The image processing device according to claim 1, further comprising
a user interface unit operable to receive an instruction from a user,
wherein said spatial composition specification unit is further operable to correct the specified spatial composition according to the received user's instruction.

11. The image processing device according to claim 1, further comprising
a spatial composition template storage unit operable to store a spatial composition template which is a template of spatial composition,
wherein said spatial composition specification unit is operable to select one spatial composition template from said spatial composition storage unit, utilizing the characteristic of the obtained still image, and to specify the spatial composition using the selected spatial composition template.

12. The image processing device according to claim 1,
wherein said three-dimensional information generation unit is further operable to calculate a contact point at which the object comes in contact with a horizontal plane in the spatial composition, and to generate the three-dimensional information for the case where the object is located in the position of the contact point.

13. The image processing device according to claim 12,
wherein said three-dimensional information generation unit is further operable to change a plane at which the object comes in contact with the spatial composition, according to a type of the object.

14. The image processing device according to claim 12,
wherein, in the case of not being able to calculate the contact point at which the object comes in contact with the horizontal plane in the spatial composition, said three-dimensional information generation unit is further operable (a) to calculate a virtual contact point at which the object comes in contact with the horizontal plane, by interpolating or extrapolating at least one of the object and the horizontal plane, and (b) to generate the three-dimensional information for the case where the object is located in the virtual contact point.

15. The image processing device according to claim 1,
wherein said three-dimensional information generation unit is further operable to generate the three-dimensional information by placing the object in the space after applying a predetermined thickness to the object.

16. The image processing device according to claim 1,
wherein said three-dimensional information generation unit is further operable to generate the three-dimensional information by applying an image processing of blurring a periphery of the object or sharpening the periphery of the object.

17. The image processing device according to claim 1,
wherein said three-dimensional information generation unit is further operable to construct at least one of background data and data of another object which is hidden behind the object, using data of the unhidden part.

18. The image processing device according to claim 17,
wherein said three-dimensional information generation unit is further operable to construct data representing a back face and a lateral face of the object, based on data representing a front face of the object.

19. The image processing device according to claim 18,
wherein said three-dimensional information generation unit is further operable to dynamically change a process regarding the object, based on a type of the object.

20. An image processing method for generating three-dimensional information from a still image, said method comprising:
an image obtainment step of obtaining a still image;
an image extraction step of extracting an object from the obtained still image;
a spatial composition specification step of specifying, using a characteristic of the obtained still image, a spatial composition representing a virtual space which includes a vanishing point; and
a three-dimensional information generation step of determining placement of the object in the virtual space by associating the extracted object with the specified spatial composition, and generating three-dimensional information regarding the object based on the determined placement of the object.

21. A program for use by an image processing device which generates three-dimensional information from a still image, said program causing a computer to execute the steps of:
an image obtainment step of obtaining a still image;
an object extraction step of extracting an object from the obtained still image;
a spatial composition specification step of specifying, using a characteristic of the obtained still image, a spatial composition representing a virtual space which includes a vanishing point; and
a three-dimensional information generation step of determining placement of the object in the virtual space by associating the extracted object with the specified spatial composition, and generating three-dimensional information regarding the object based on the determined placement of the object.
